(19) United States
(12) Patent Application Publication
(10) Pub. No.: US 2011/0319018 A1
(43) Pub. Date: Dec. 29, 2011

(54) METHOD FOR ESTABLISHING SHORT-RANGE, WIRELESS COMMUNICATION BETWEEN A MOBILE PHONE AND A HEARING AID

(75) Inventor: Morten KROMAN, Taastrup (DK)

(73) Assignee: WIDEX A/S, Lynge (DK)

(21) Appl. No.: 13/227,874

(22) Filed: Sep. 8, 2011

Related U.S. Application Data
(63) Continuation-in-part of application No. PCT/DK2009/050066, filed on Mar. 23, 2009.

(51) Int. Cl. H04W 88/02; H04R 25/00; H04B 5/00

(52) U.S. Cl. 455/41.1

(57) ABSTRACT

A method for establishing short-range, wireless communication between a mobile phone and a hearing aid comprises the steps of: providing a mobile phone having means for short-range, wireless communication, providing a first signal representing an audio signal for reproduction by the mobile phone, providing a hearing aid having means for short-range, wireless communication, pairing the mobile phone to the hearing aid by means of the short-range, wireless communication means, and transmitting the first signal from the mobile phone to the hearing aid by means of the short-range, wireless communication means. The invention further provides a hearing aid (3) comprising means for communication with a mobile phone (2).

### RELATED APPLICATIONS

The present application is a continuation-in-part of application No. PCT/EP2009050066, filed on Mar. 23, 2009, in Europe and published as WO2010108492 A1.

### BACKGROUND OF THE INVENTION

1. FIELD OF THE INVENTION

The present invention relates to a method for establishing short-range, wireless communication between a mobile phone and a hearing aid. The invention further relates to a hearing aid comprising means for short-range, two-way, wireless communication with a mobile phone.

A contemporary hearing aid is a small, electronic device for aiding the hearing of a person having a hearing impairment. In its bare essentials, a hearing aid comprises a microphone, an amplifier and a reproduction receiver. The hearing aid is usually a tiny device, small enough to be worn behind or in a user's ear during use, and may comprise wireless circuitry for receiving signals wirelessly from e.g. a remote control, a programming device or another hearing aid. Prior to use, the hearing aid is programmed individually by a hearing aid fitting professional according to a prescription in order to amplify frequency ranges which are hard to perceive by the user.

Many contemporary mobile phones comprise circuitry for communicating wirelessly with other devices over short distances, i.e. 5-10 m, distinguishable from the common wireless GSM communication for a cellular network by their frequency ranges and communications protocol. One well-known wireless communications system is denoted Bluetooth®, and the term “other devices” may include other mobile phones, headsets, Global Positioning System units, personal computers, printers and other devices that may provide a benefit from communicating wirelessly with the mobile phone.

In order to allow communication, a procedure known as pairing has to be performed in order to identify different devices trying to communicate via the Bluetooth® link simultaneously. This pairing procedure, which takes place in order to identify the intended device and for security reasons, involves the user entering identification codes or other information into the mobile phone, said codes often only being accessible in the mobile phone through a series of complicated menus in dependency of the make of the mobile phone and its operating system structure. This procedure is therefore considered to be troublesome to the user, especially if several different devices are used.

Recent innovations in mobile phone designs have provided mobile phones with a secondary, short-range wireless communication system, commonly known as Near Field Communication, abbreviated NFC. The NFC circuit is a two-way communication circuit comprising both a transmitter and a receiver. NFC is a mainly inductive communication system, which has a very short effective transmission range, such as approximately 5-6 centimetres. The protocol used for wireless near field communication via NFC is well described. Using NFC enables a user to simplify the otherwise cumbersome Bluetooth® pairing procedure by temporarily bringing a mobile phone comprising both Bluetooth® and

NFC circuitry within the effective NFC transmission range of 5-6 centimetres of another device, which also comprises both Bluetooth® and NFC circuitry, e.g. an after-market headset, and then let the NFC circuits automatically exchange information between the devices, in order to perform the Bluetooth® pairing procedure of the two devices. After the pairing, the two paired devices are separated again but will now be able to communicate via Bluetooth®, e.g. streaming audio to the head-set from the mobile phone and vice versa, as long as they are within the Bluetooth® communication range. The NFC is only used as long as the two devices are close together, and after separation of the devices, it is no longer used for any communication between the devices.

2. The Prior Art

EP-A-1933594 discloses a hearing aid having an active transponder for detecting the presence of e.g. a telephone or a remote control device, said telephone or remote control device having built in a passive transponder adapted for transmitting a predetermined signal upon being energized by the active transponder in the hearing aid, said hearing aid entering a predetermined signal processing state upon reception of the signal from the passive transponder.

US-A-2008/0025537 discloses a hearing aid having a radio frequency identification receiver for communicating wirelessly with a radio-frequency identification (RFID) tag for the purpose of engaging a predetermined program in the hearing aid when the presence of a suitable RFID tag is detected. If such an RFID tag is attached to the handset of a telephone, the hearing aid may automatically enter a telephone program, when the RFID tag is detected by the hearing aid.

Though it might seem evident to implement NFC and Bluetooth® in a hearing aid in order to allow the hearing aid to pair with a mobile phone and establish a communication, which, as a bonus effect, could even be two-way rather than the above-mentioned one-way communication, this solution suffers from the drawback that the power consumption necessary for Bluetooth® communication is incompatible with the low energy consumption constrictions of a hearing aid.

### SUMMARY OF THE INVENTION

Based on this prior art it is a feature of the present invention to provide an improved method for communication between a hearing aid and another device, in particular a mobile phone. According to a first aspect of the invention this feature is achieved by a method for establishing short-range, wireless communication between a mobile phone and a hearing aid, said method comprising the steps of: providing a mobile phone having means for short-range, wireless communication using an NFC communications protocol, providing a first signal representing an audio signal for reproduction by the mobile phone, providing a hearing aid having means for short-range, wireless communication using an NFC communications protocol, pairing the mobile phone to the hearing aid by means of the short-range, wireless communication means, and transmitting the first signal as a continuous data stream from the mobile phone to the hearing aid by means of the short-range, wireless communication means.

Thereby, the short-range, two-way wireless communication, for which the mobile telephone is normally enabled, may be used to stream the audio directly to a hearing aid without the use of an additional transmission media such as the inductive coupling to a telecoil or a Bluetooth® link. In other words, the inventor has realised that in situations where devices are to be kept closely together, the above-mentioned well described protocol used for wireless near field communication via NFC, which is designed for exchange of smaller amounts of data in the temporary process of pairing devices, can be used for real-time streaming of a signal representing an audio signal as a continuous data stream, because the bitrate provided in the NFC is sufficiently large to allow this.

The invention, in a second aspect, provides a hearing aid comprising a wireless circuit for short-range, two-way, wireless communication with a mobile phone using an NFC communications protocol, said hearing aid comprising means for receiving via said short-range, two-way wireless communication a first signal comprising a continuous data stream representing an audio signal, means for decoding the received data stream into a format suitable for reproduction, means for controlling the reception and decoding of the data stream, and means for reproducing the audio signal.

This is particularly advantageous, as many hearing aids already comprise means for short-range, two-way wireless communication, which if necessary may be utilised for NFC communication without major modifications, e.g. by using one and the same antenna. Moreover, such short-range, two-way wireless communication has low power consumption and is thus well suited for hearing aids.

In other words, the present invention provides a novel way of using the NFC circuit in a mobile phone together with a hearing aid. Basically, all which is needed is providing the hearing aid with its own NFC circuit capable of communicating with the mobile phone wirelessly via the NFC communication channel, providing suitable software for the operating system of the mobile phone, said software enabling redirection of a digital audio stream initially intended for the loudspeaker of the mobile phone to the NFC circuit of the mobile phone, transmitting the digital audio stream wirelessly from the NFC circuit of the mobile phone to the NFC circuit of the hearing aid (given a sufficiently short distance between the mobile phone and the hearing aid to allow reception of the wireless

NFC signal), receiving the digital audio stream wirelessly in the NFC circuit of the hearing aid, decoding the digital audio stream in the hearing aid, and reproducing the decoded audio stream as audible signals by the hearing aid receiver. This enables the mobile phone to be used by a hearing impaired hearing aid user in a way similar to the way a mobile phone is used by a person with normal hearing. When a call to the mobile phone is made, the user answers the call by pressing the appropriate button on the mobile phone user interface and lifts the mobile phone up to his or her ear, close to where the hearing aid is present and operating. Then the mobile phone connects to the hearing aid via NFC and starts streaming the audio signals as a wireless, digital data stream to the hearing aid via the NFC link.

This has the advantage that no additional devices (e.g. Bluetooth® link bridges etc.) are needed for receiving the call, and the hearing aid user may keep wearing the hearing aid for the duration of the call, as opposed to having to remove the hearing aid in order to use the mobile phone, rendering the hearing aid prone to being lost and the hearing aid user without compensation for his or her hearing loss for the duration of the call.

A further advantage is that the NFC circuit is already built into the mobile phone at the time of purchase, and no extra hardware needs to be obtained.

According to a preferred embodiment according to the first aspect of the invention the step of transmitting the first signal from the mobile phone to the hearing aid is initiated by executing a suitable program in the mobile phone. This allows for automatic switching between the audio signal being sent to the speaker of the mobile phone, and the audio signal -or a data signal representing it, e.g. in an encoded and/or compressed digital format, being sent to the hearing aid.

According to a preferred embodiment according to the second aspect of the invention, said means for controlling the reception and decoding of the data stream comprises further means for short range, two way wireless communication. This allows for the short-range, two-way wireless communication, or at least part of it to take place via an existing means for short-range, two-way wireless communication, rather than the NFC.

More specifically in this further preferred embodiment according the second aspect of the invention, the NFC functionality of the hearing aid is made available by means of an existing, wireless circuit primarily intended for communication with another hearing aid. This circuit exchanges data wirelessly with another hearing aid, preferably using a radio frequency different from the standardized NFC frequency of 13.56 MHz, preferably approximately 10 MHz. The circuit is thus capable of using both radio frequencies in an alternating manner, perhaps changing its reception briefly to the NFC frequency at regular, idle moments for detecting the presence of an NFC transmitter.

### BRIEF DESCRIPTION OF THE DRAWINGS

For better understanding of the merits and advantages of the present invention it will now be described in greater detail based on nonlimiting exemplary embodiments and the accompanying schematic drawing.

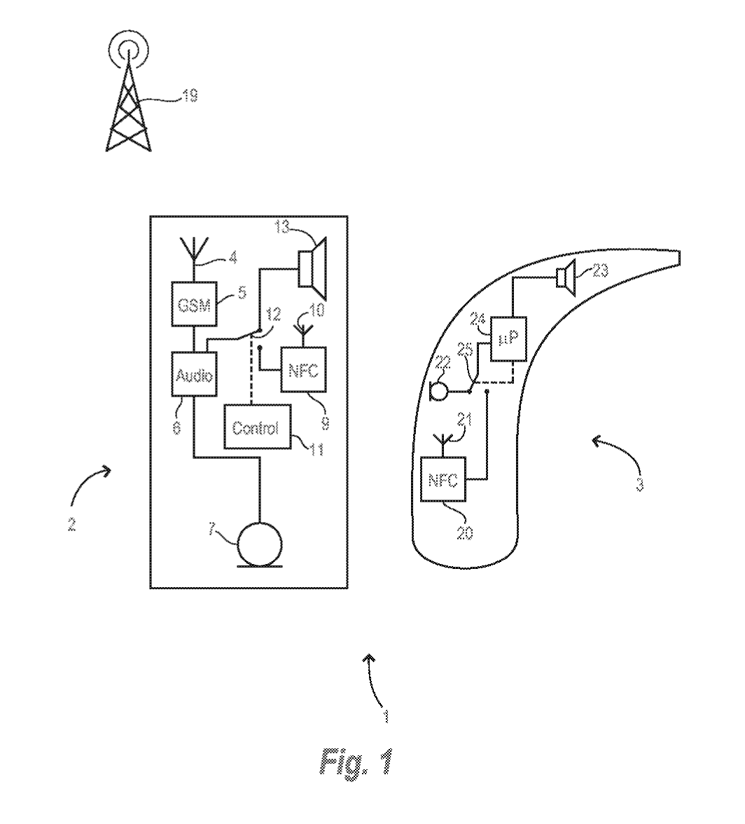

In the drawing FIG. 1 illustrates schematically a system comprising an NFC-enabled mobile phone and a hearing aid.

### DETAILED DESCRIPTION OF THE INVENTION

FIG. 1 shows a system 1 comprising an NFC-enabled mobile phone 2 and an NFC-enabled hearing aid 3. The mobile phone 2 comprises a GSM antenna 4, a GSM transceiver and decoder 5, a digital audio codec 6, a microphone 7, a first NFC transceiver 9 having a first NFC antenna 10, a mobile phone controller 11, a first switch 12 and a loudspeaker 13. The hearing aid 3 comprises a second NFC transceiver 20 having a second NFC antenna 21, a microphone 22, an audio receiver 23, a processor 24, and a second switch 25. Also shown in the figure is a GSM cell 19 for enabling communications between the mobile phone 2 and a GSM network (not shown). During use, the GSM cell 19 usually performs call handling between the GSM network and the mobile phone 2, the mobile phone 2 receiving speech signals from the microphone 7 for coding into suitable digital form by the digital audio codec 6 and transmitting the resulting digital signal to the GSM cell 19 via the GSM transceiver 5 and the GSM antenna 4, and decoding a received digital signal into speech by the audio codec 6 for reproduction by the loudspeaker 13 via the first switch 12. As an alternative, the encoded speech signal as received via the GSM transceiver may be relayed directly to the hearing aid 3 to be decoded there, i.e. without decoding and re-encoding in the mobile telephone 2.

The mobile phone controller 11 controls the position of the first switch 12, and may initiate redirecting the audio signals from the audio codec 6 to the first NFC transceiver 9 for transmission to the second NFC transceiver 20 via the first NFC antenna 10 and the second NFC antenna 21. The mobile controller 11 may be implemented as a suitable programme, e.g. in Java, running on the mobile phone 2, and allowing the use of the keys of the keyboard and of the display on the mobile phone for selecting the NFC transceiver for output rather than the loudspeaker 13 or vice versa. Alternatively, the mobile controller may be implemented as a suitable programme adapted for switching automatically to the NFC transceiver 9 as output source, when the NFC transceiver 9 detects the presence of an NFC enabled hearing aid 3.

The processor 24 in the hearing aid 3 controls the second switch 25, and may select between audio signals from the microphone 22 and signals from the second NFC transceiver 20 to be reproduced by the audio receiver 23. This selection is preferably automatic in response to the second NCF transceiver 20 in the hearing aid 3, e.g. when the hearing aid user wants to make or receive a call using the telephone and consequently holds it against his ear.

The effect of this arrangement is that speech signals received via the GSM network (i.e. a call from another telephone or mobile phone) may be transmitted from the mobile phone 2 to the hearing aid 3 via the first and second NFC transceivers 9 and 20, respectively, provided that they are within proper reception range of each other, i.e. not more than 5-6 centimetres apart. The NFC protocol inherently has identification and handshaking codes for making the mobile phone 2 and the hearing aid 3 aware of each other's presence, and the mobile phone controller 11 may direct a digital audio stream to the hearing aid via the first and the second NFC transceivers 9 and 20, respectively, either automatically, when a suitable, NFC-enabled hearing aid 3 is detected by the first NFC transceiver 9, or initiated by the user via the user interface (not shown) of the mobile phone 2.

Once identification has been performed, the first NFC transceiver 9 starts streaming data representing the speech signals received by the phone to the second NFC transceiver 20 in the hearing aid 3, the hearing aid processor decoding the received data stream and processing the sound according to the user profile for reproduction by the audio receiver 23. NFC currently offers data transfer rates of 106 kbits/s, 212 kbits/s and 424 kbits/s, which is sufficient for audio streaming. The hearing aid transmits handshake commands and acknowledge receipt telegrams back to the telephone handset via the NFC, which thus serves for two-way communication, though speech is carried only one-way. Sound, in particular speech, from the hearing aid user is picked up by the normal microphones of the telephone handset.

Some hearing aids 3 already implement short-range inductive communications. It may therefore be advantageous to implement the second NFC transceiver 20 and antenna 21 in conjunction with existing hardware, e.g. allowing at least some of: detection, pairing, audio streaming or data exchange to be performed using the existing hardware. Though designed for 13.56 MHz the antennas 10 and 13 could readily be used for communication at e.g. 10 MHz and vice versa. Thus no substantial modification of the hearing aid hardware would be necessary.

The system described above provides a significant advantage for a hearing aid user when using a mobile phone 2, as he or she does not have to change any habits or wear any intermediate devices apart from the hearing aid 3 when using the mobile phone 2.

Though the present invention takes its origin in the idea of easy short range streaming of audio, the skilled person will realise that other types of data than encoded audio data could be transmitted this way. Thus, data relating to the settings of the hearing aid could readily be transmitted to and from the hearing aid 3 via a mobile telephone 2, thus enabling remote update of the hearing aid software and program settings. Also, a mobile phone could be used for in-situ fitting, sending a predetermined signal to the hearing aid via the mobile phone, allowing the user to indicate hearing the signal or not, e.g. by pressing an appropriately key on the mobile phone, or as speech recognition of a verbal response.

1. A method for establishing short-range, wireless communication between a mobile phone and a hearing aid, said method comprising the steps of:
providing a mobile phone having means for short-range, wireless communication using an NFC communications protocol,
providing a first signal representing an audio signal for reproduction by the mobile phone,
providing a hearing aid having means for short-range, wireless communication using an NFC communications protocol,
pairing the mobile phone to the hearing aid by means of the short-range, wireless communication means, and
transmitting the first signal as a continuous data stream from the mobile phone to the hearing aid by means of the short-range, wireless communication means.

2. The method according to claim 1, wherein the step of pairing the mobile phone to the hearing aid is performed using an NFC communications protocol.

3. The method according to claim 1, wherein the step of transmitting the first signal from the mobile phone to the hearing aid is initiated by executing a respective program in the mobile phone.

4. A hearing aid comprising a wireless circuit for short-range, two-way, wireless communication with a mobile phone using an NFC communications protocol, said hearing aid comprising means for receiving via said short-range, two-way wireless communication a first signal comprising a continuous data stream representing an audio signal, means for decoding the received data stream into a format suitable for reproduction, means for controlling the reception and decoding of the data stream, and means for reproducing the audio signal.

5. The hearing aid according to claim 4, wherein said wireless circuit is adapted for communicating with another hearing aid.

6. The hearing aid according to claim 5, wherein said wireless circuit is adapted for communicating with another hearing aid using a radio frequency different from the standardized NFC frequency.

7. The hearing aid according to claim 6, wherein said wireless circuit is adapted for communicating with another hearing aid using a radio frequency of approximately 10 MHz.

8. The hearing aid according to claim 5, wherein said wireless circuit uses the same antenna for communicating with a mobile phone and for communicating with another hearing aid.

9. The hearing aid according to claim 6, wherein said wireless circuit uses both frequencies in an alternating manner.
